(19) United States
(12) Patent Application Publication
(10) Pub. No.: US 2010/0290380 A1
(43) Pub. Date: Nov. 18, 2010

(54) Wireless Communication Device, Power Saving Method Thereof, and Packet Filtering Method Therefor

(75) Inventors: Chuan-Ming Tsai, Taipei Hsien (TW); Yung-Shih Chi, Taipei Hsien (TW)

Correspondence Address: Tolpin & Partners, PC, 11 S. LaSalle Street, Suite 2900, Chicago, IL, 60603, US

(73) Assignee: Acer Incorpoated, Taipei County (TW)

(21) Appl. No.: 12/582,202

(22) Filed: Oct. 20, 2009

(30) Foreign Application Priority Data
May 15, 2009 (TW) 098116325

(51) Int. Cl. G08C 17/00

(52) U.S. Cl. 370/311

(57) ABSTRACT

A wireless communication device, a power saving method thereof, and a packet filtering method therefor are disclosed. The wireless communication device includes a modem connected to a wireless network system for receiving and transmitting packet data, and a data processor for executing an application program to access network services via the wireless network system. When the data processor is entering to hibernate mode, network information corresponding to the application program is generated, such as a communication port number or an Internet Protocol (IP) address. The modem then filters the received packet data based on the network information. Only when communication port number or IP address contained in the received packet data matches the network information, the modem will wake up the data process to process the received packet data. Therefore, the hibernation time of the data processor is extended to effectively reduce the power consumed by the wireless communication device.

### FIELD OF THE INVENTION

The present invention relates to a wireless communication device, a power saving method thereof, and a packet filtering method therefor; and more particularly to a wireless communication device that includes a modem capable of filtering received packet data, so as to extend the hibernation time of main processor of the wireless communication device and accordingly reduce the power consumption of the wireless communication device.

### BACKGROUND OF THE INVENTION

Various kinds of new generation wireless communication system have become very popular among people now, allowing users not only to wirelessly communicate with one another, but also access Internet at any time and any place with higher bandwidth through a wireless communication device to browse web pages or enjoy network services. Since the currently available wireless communication devices are provided with more and more functions, and the frequency users operate the wireless communication devices is higher than ever before, most users tend to encounter insufficient battery power of the wireless communication devices and accordingly relatively short operable time thereof.

Generally, user does not operate the wireless communication device all the time. In the case of a conventional wireless communication device that provides only the phone call function, a processor of the wireless communication device will go to a hibernation mode when the user does not make or receive phone calls. While receiving an incoming call a modem thereof will wake up the processor to execute a corresponding application program to, for example, display the caller's name, and output a corresponding ring signal and/or show a corresponding image indicating an incoming call. However, in the case of a wireless communication device that also provides the function of accessing Internet wirelessly, the wireless communication device may keep receiving packet data from a remote server even when the user is currently not using or viewing the wireless services, and the processor of the wireless communication device in the hibernation mode is then waken up to process the received packet data. The hibernation mode for the processor can reduce the power consumption of the wireless communication device and is a very common scheme of power saving for most wireless communication devices.

However, while connecting with Internet, the current networking systems usually suffer from the attack of Internet hackers. In addition to normal or regular packet data, wireless communication devices also frequently receive packet data sent by vicious Internet hackers, such as packet data requesting for scanning communication ports. Such vicious packet data is useless for users but the processor must be frequently waken up to process such vicious packet data, and it would result in shortened hibernation time for processor and accordingly, further result in poor power saving effect. That is, the wireless communication device is not in use but the processor thereof always maintains in the operating state instead of the hibernation mode, resulting in unnecessary power consumption by the wireless communication device.

### SUMMARY OF THE INVENTION

It is therefore one of objects of the present invention to provide a wireless communication device, a power saving method thereof, and a packet filtering method therefor, so as to efficiently extend the hibernation time of a processor of the wireless communication device and accordingly reduce the power consumption thereof.

To achieve the above and other objects, the wireless communication device according to the present invention is for using with a wireless network system, and includes a modem being connected to the wireless network system for receiving or transmitting at least one packet date and a data processor for executing an application program to access network services via the wireless network system. When a preset condition occurs, the data processor generates network information corresponding to the application program, and the modem then filters at least one received packet data based on the network information.

Preferably, the network information includes a communication port number or an Internet Protocol (IP) address.

Preferably, the communication port number recorded in the network information represents a communication port being used by the application program in data transmission, and the IP address recorded in the network information represents an IP address of a remote server with which the application program transmits data in the wireless network system.

Preferably, the preset condition is that the data processor is entering to hibernate mode, and the modem determines whether to wake up the data processor based on a result of filtering the packet data.

To achieve the above and other objects, the packet filtering method according to the present invention is applicable to a wireless communication device having a modem for receiving at least one packet data and a data processor for executing an application program. The packet filtering method includes the following steps. It is determined whether a preset condition occurs. network information corresponding to the application program is generated when it is determined the preset condition occurs. The modem then filters the at least one packet data based on the network information.

Preferably, the network information includes a communication port number or an Internet Protocol (IP) address.

Preferably, the communication port number recorded in the network information represents a communication port being used by the application program in data transmission, and the IP address recorded in the network information represents an IP address of a remote server with which the application program transmits data in the wireless network system.

Preferably, the preset condition is that the data processor is entering to hibernate mode, and the modem determines whether to wake up the data processor based on a result from filtering the packet data.

To achieve the above and other objects, the power saving method according to the present invention is applicable to a wireless communication device having a modem for receiving at least one packet data and a data processor for executing an application program. The packet filtering method includes the following steps: (1) determining whether the data processor is entering to hibernate mode; (2) generating network information related to the application program when it is determined the data processor is entering to hibernate mode; and (3) the modem filtering the at least one packet data based on the network information so as to determine whether to wake up the data processor.

Preferably, the network information includes a communication port number or an Internet Protocol (IP) address.

Preferably, the communication port number recorded in the network information represents a communication port being used by the application program in data transmission, and the IP address recorded in the network information represents an IP address of a remote server with which the application program transmits data in the wireless network system.

Preferably, the modem wakes up the data processor to process a packet data when communication port number or IP address in the packet data matches the network information.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a wireless communication device according to the present invention;

FIG. 2 is a table exemplifying network information employed in the present invention;

FIG. 3 is a flowchart showing the steps included in a packet filtering method for wireless communication device according to the present invention; and

FIG. 4 is a flowchart showing the steps included in a power saving method for wireless communication device according to the present invention.

### DETAILED DESCRIPTION OF THE PREFERRED EMBODIMENTS

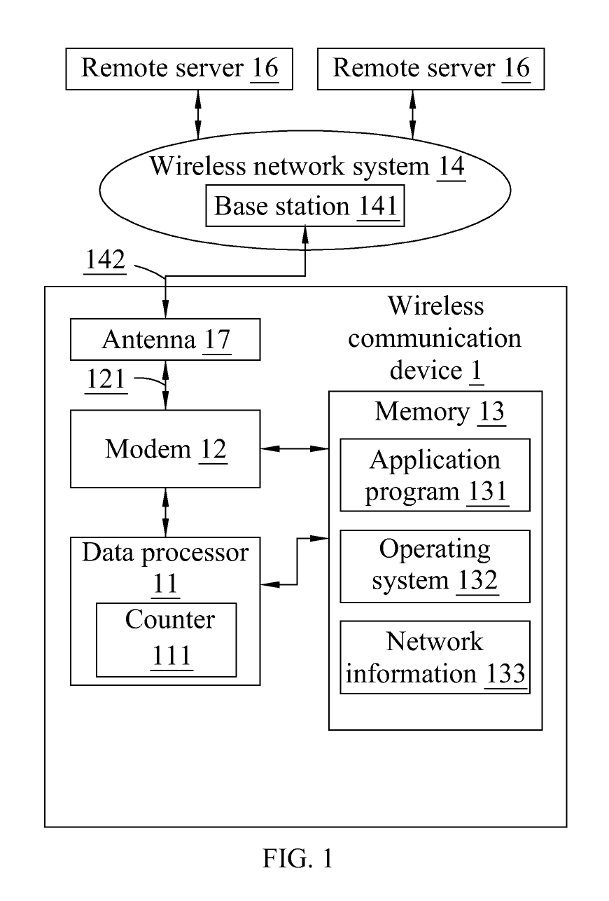

Please refer to FIG. 1 that is a block diagram of a wireless communication device 1 according to the present invention. As shown, the wireless communication device 1 includes a data processor 11, a modem 12, a memory 13, and an antenna 17. The memory 13 is used to store digital data, such as an application program 131 and an operating system 132 that can be executed by the data processor 11, as well as data generated by the data processor 11. The antenna 17 receives radio wave 142 transmitted from any base station 141 in a wireless network system 14, and converts the radio wave 142 into an analog signal containing a packet data 121. The modem 12 is electrically connected to the wireless network system 14 via the antenna 17, so as to receive the packet data 121 from the base station 141 via the antenna 17 or to transmit a packet data 121 to the base station 141. Preferably, the wireless network system 14 is a WIFI system, a GPRS (General Packet Radio Service) system, a 3G system, or other network systems for wirelessly transmitting packets.

The data processor 11 executes the operating system 132 to provide an environment for running the application program 131. When being executed, the application program 131 may connect to a remote server 16 via the wireless network system 14 for access of network services. For example, the application program 131 can be an instant messaging (IM) program, and capable of linking to an instant messaging server while being executed, so that a user can communicate with his or her friend over the wireless communication device 1 by sending instant messages to each other.

When a preset condition occurs, the data processor 11 generates related network information 133 corresponding to the application program 131, and the modem 12 then filters the packet data 121 based on the network information 133. Preferably, the preset condition can be that the data process 11 is entering to hibernation mode. For example, when the data processor 11 has not received any operating command for a time period which is counted by a counter 111, and the count value exceeds a preset time value, it indicates that the user has not operated the wireless communication device 1 during the counted time and may not operate the wireless communication device 1 in a short time, then the data processor 11 will automatically enter to a hibernation mode to reduce its power consumption. Before entering to hibernation mode, the data processor 11 will save network information 133 related to the application program which is currently being executed to the memory 13. For instance, to do so, the operating system will detect the currently being used communication port number 134 or the Internet protocol (IP) address 135 of a remote server 16 currently communicating with the application program. Then, the modem 12 starts filtering the received packet data 121 based on the network information 133 and determines based on a filtering result whether to wake up the data processor 11 that is currently in the hibernation mode.

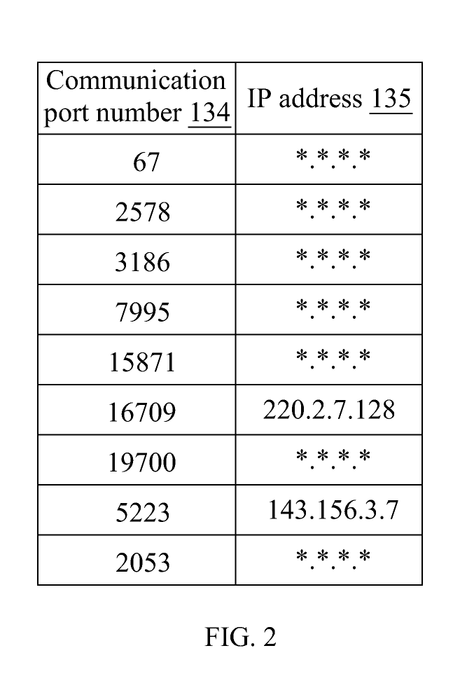

FIG. 2 shows a table exemplifying some network information that can be employed in the present invention. In the exemplary table, there are shown nine groups of communication port number 134 and IP address 135 related to the application program. When a user has not operated the wireless communication device 1 for a certain period of time but does not close the application program, it is determined the user wants the application program to keep linking with the remote server 16 for use when the user operates the wireless communication device 1 again. Therefore, when the data processor 11 goes to hibernate to reduce the power consumption thereof, the modem 12 receiving packet data 121 will wake up the data processor 11 to process the packet data 121 transmitted from the remote server 16 whose IP is stored in table shown in FIG. 2, or the packet data 121 received via the communication port stored in table shown in FIG. 2.

Some of the packet data are transmitted by Internet hackers or some kind of virus program to request for, for example, scanning the communication ports. The frequency for the modem 12 to receive such hacker-transmitted packet data is high. The number of times of waking up the data processor 11 will largely increase if the data processor 11 were waken up each time a packet data is received, including the hacker-transmitted packet data. As a result, the time period during which the data processor 11 goes to hibernate is shortened to lower the power-saving effect. Therefore, according to the present invention, the modem 12 filters the packet data 121 based on the network information 133. For instance, when a destination port number in the received packet data matches the data recorded in the network information 133, such as a destination port number 2578 that indicates the packet data is to be transmitted to a second application program, the modem 12 will wake up the data processor 11 to execute the second application program for processing the received packet data. Or, when a source address in the received packet data matches the data recorded in the network information 133, it indicates the packet data is transmitted from a server that was previously communicating with the application program 131 and requires the data processor 11 to process, the modem 12 will wake up the data processor 11 for the latter to process the packet data and make proper response to the server and accordingly maintain linking with the server. On the other hand, when the destination port number and the source address in the received packet data do not match the network information 133, the modem 12 will not wake up the data processor 11.

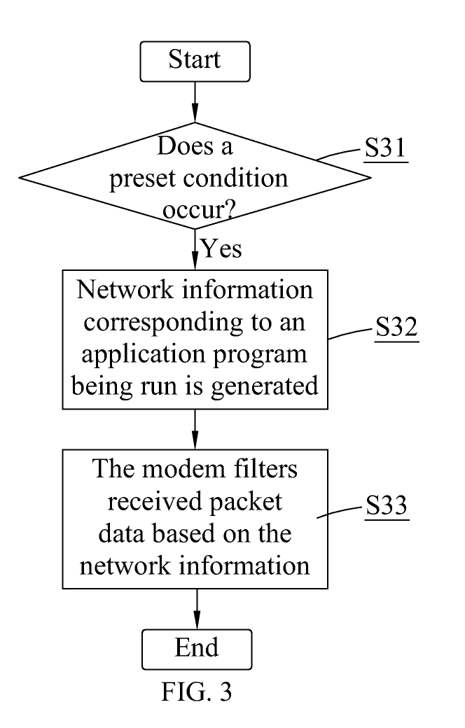

FIG. 3 is a flowchart showing the steps included in a packet filtering method according to the present invention. The packet filtering method is applicable to a wireless communication device that includes a modem for receiving at least one packet data and a data processor for executing an application program. As shown, in a first step S31 of the packet filtering method, it is determined whether a preset condition occurs or not. If the preset condition occurs, in a second step S32, network information related to the application program, such as a communication port number that is currently used by the application program or an IP address of the received packet data, is generated. Then, in a third step S33, the modem filters the received packet data based on the network information.

Preferably, the network information, based on which the packet data is filtered, is automatically generated by the wireless communication device. However, it is understood some part of the network information can also be manually set by a user according to actual need.

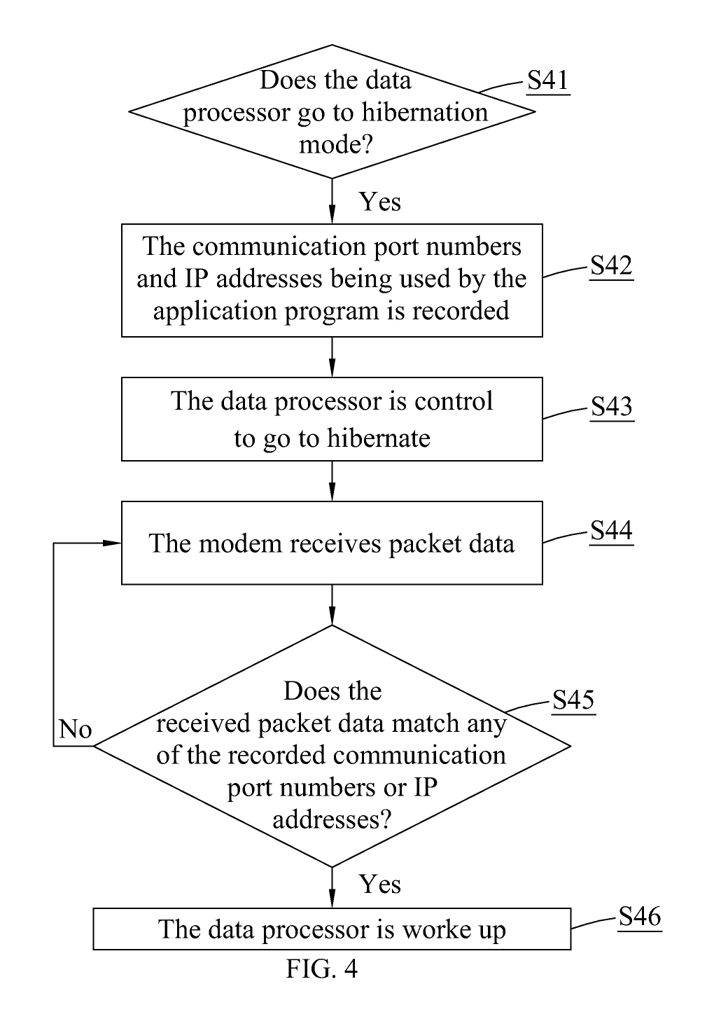

FIG. 4 is a flowchart showing the steps included in a power saving method according to the present invention. The power saving method is applicable to the wireless communication device 1 configured as FIG. 1, and the following description of the method is based on an implementation of the method on the wireless communication device 1. As shown, in a first step S41 of the power saving method, it is determined whether an accumulated count by the counter 111 exceeds a preset threshold value. If yes, it means the user has not operated the wireless communication device 1 for a quite long period of time, and accordingly, the data processor 11 is ready to go to hibernate to reduce the power consumption thereof. In a second step S42, when the accumulated count by the counter 111 exceeds the preset threshold value, the operating system 132 detects and records the communication port numbers 134 that are currently used by all the application programs 131, and then, the application programs 131 record the IP addresses 135 of the remote servers 16 that are currently communicating with the wireless communication device 1. In a third step S43, the data processor 11 goes to hibernate under control. In a fourth step S44, the modem 12 receives packet data. In a fifth step S45, the modem 12 determines whether the received packet data matches any of the recorded communication port numbers 134 or IP addresses 135. If yes, go to the sixth step S46 to wake up the data processor 11 to process the received packet data; or if not, return to the fourth step S44.

The wireless communication device, the power saving method thereof, and the packet filtering method therefor according to the present invention provide at least one of the following advantages:

(i) Allow the data processor to have effectively extended hibernation time to reduce the power consumption of the wireless communication device;

(ii) The network information for filtering the received packet data can be automatically generated by the wireless communication device to provide the user with increased operating convenience; and

(iii) Potential packet data containing computer virus can be effectively filtered off to enhance the security of the wireless communication device in use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A wireless communication device for use with a wireless network system, comprising:
a modem being electrically connecting to the wireless network system for receiving and/or transmitting at least one packet data; and
a data processor for executing an application program to access a network service via the wireless network system;
wherein when a preset condition occurs, the data processor generates network information corresponding to the application program, and the modem filters the at least one packet data based on the network information.

2. The wireless communication device as claimed in claim 1, wherein the network information comprises a communication port number or an Internet Protocol (IP) address.

3. The wireless communication device as claimed in claim 2, wherein the communication port number recorded in the network information represents a communication port being used by the application program in data transmission.

4. The wireless communication device as claimed in claim 3, wherein the data processor executes an operating system (OS), and the OS detects the communication port number being used by the application program.

5. The wireless communication device as claimed in claim 2, wherein the IP address recorded in the network information represents an IP address of a remote server with which the application program transmits data in the wireless network system.

6. The wireless communication device as claimed in claim 1, wherein the preset condition is that the data processor is entering to hibernate mode.

7. The wireless communication device as claimed in claim 6, wherein the modem determines whether to wake up the data processor based on a result of filtering the at least one packet data.

8. The wireless communication device as claimed in claim 7, wherein the modem wakes up the data processor to process the received packet data when communication port number or IP address contained in the received packet data matches the network information.

9. A packet filtering method applicable to a wireless communication device, the wireless communication device including a modem for receiving at least one packet data and a data processor for executing an application program, the packet filtering method comprising the following steps:
determining whether a preset condition occurs;
generating a network information corresponding to the application program when it is determined the preset condition occurs; and
using the modem to filter the at least one packet data based on the network information.

10. The packet filtering method as claimed in claim 9, wherein the network information comprises a communication port number or an Internet Protocol (IP) address.

11. The packet filtering method as claimed in claim 10, wherein the communication port number recorded in the network information represents a communication port being used by the application program in data transmission.

12. The packet filtering method as claimed in claim 11, when the data processor executes an operating system (OS), further comprising the following step
using the OS to detect the communication port number being used by the application program.

13. The packet filtering method as claimed in claim 10, wherein the IP address recorded in the network information represents an IP address of a remote server with which the application program transmits data in the wireless network system.

14. The packet filtering method as claimed in claim 11, wherein the preset condition is that the data processor is entering to hibernate mode; and the modem determines whether to wake up the data processor based on a result of filtering the at least one packet data.

15. A power saving method for a wireless communication device, the wireless communication device including a modem for receiving at least one packet data and a data processor for executing an application program, the power saving method comprising the following steps:
determining whether the data processor is going to hibernate mode;
generating a network information corresponding to the application program when it is determined the data processor is going to hibernate mode; and
using the modem to filter the at least one packet data based on the network information and determining whether to wake up the data processor based on a result of filtering the packet data.

16. The power saving method as claimed in claim 15, wherein the network information comprises a communication port number or an Internet Protocol (IP) address.

17. The power saving method as claimed in claim 16, wherein the communication port number recorded in the network information represents a communication port being used by the application program in data transmission.

18. The power saving method as claimed in claim 17, when the data processor executes an operating system (OS), further comprising the following step:
using the OS to detect the communication port number being used by the application program.

19. The power saving method as claimed in claim 16, wherein the IP address recorded in the network information represents an IP address of a remote server with which the application program transmits data in the wireless network system.

20. The power saving method as claimed in claim 17, wherein the modem wakes up the data processor to process the received packet data when communication port number or IP address contained in the received packet data matches the network information.
